(19) United States
(12) Patent Application Publication
(10) Pub. No.: US 2007/0159658 A1
(43) Pub. Date: Jul. 12, 2007

(54) Index image output apparatus and index image output program

(75) Inventor: Yosuke Kato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/651,958

(22) Filed: Jan. 11, 2007

(30) Foreign Application Priority Data
Jan. 12, 2006 (JP) 2006-005016

(51) Int. Cl. H04N 1/40

(52) U.S. Cl. 358/3.21

(57) ABSTRACT

An index image consists of a plurality of thumbnail images arranged in a matrix array. The thumbnail images are produced from image data of a series of images. Where the images are recorded as RAW image data and other format image data within a series, an index image output apparatus superimposes a rectangular frame image of a particular color on each of those thumbnail images which are produced from the RAW image data, to produce a distinguishing thumbnail image. Then the index image include distinguishing thumbnail images and ordinary thumbnail images, so it is easy for the user to distinguish the RAW format images from other images of other formats.

### FIELD OF THE INVENTION

The present invention relates an index image output apparatus and an index image output program, for outputting an index image which contains a list of images as an array of thumbnails of these images.

### BACKGROUND OF THE INVENTION

Photo shops or photo-labs usually forwards an index photo print as a giveaway to the customer together with a series of photo prints made from images photographed on a photo filmstrip, or from image data captured by a digital camera. The index photo print contains a matrix-arranged thumbnails or compressed images of the corresponding series of photo prints, so that the customer may glance over the printed images. The index photo print is convenient for the customer on ordering reprinting. That is, the index photo print makes it easier to designate which image to reprint, how many reprints are to be made, in what size the reprint is to be made, and so on. Since the thumbnails roughly show the finish of the photo prints, the index photo print is also useful for the customer to ask the photo shop or photo-lab for improvement or modification of the print quality.

Meanwhile, on recording the captured image data in a storage medium, such as a memory card, conventional digital cameras compress image data, for example, according to the JPEG format, thereby to reduce the data size and thus save the requisite memory capacity. However, the JPEG compression involves degradation of the image quality due to block noises and the like. Therefore, when the image data after being compressed according to the JPEG format is processed and subjected to the JPEG compression again, the image quality is still more damaged.

Recently, memory cards get such storage capacity that they are capable of recording image data without compressing it. For example, RAW image data is obtained by digitalizing original image signals that are output from an imaging device, without processing the image signals for gradation and color correction. Although the size of the RAW image data is multiple of the size of the JPEG-compressed image data, the RAW image data allows printing a high quality image even in an enlarged print size, and degradation of the image quality is reduced to the minimum even after the image data goes through the fine-control of the image quality.

Therefore, some digital camera allows the user to choose whether to record the image data in the JPEG-compressed format or in the RAW format. Where the memory card stores the JPEG-compressed image data and the RAW image data in a mixed condition, it is desirable for the photographer or customer to discriminate the captured images between the JPEG image data and the RAW image data, especially on ordering the printing, because it is preferable to use the RAW image data for making a big size print. However, with the conventional index photo print, it is impossible to know from the thumbnails which of the images are recorded in the JPEG format and which ones are recorded in the RAW format.

### SUMMARY OF THE INVENTION

In view of the foregoing, a primary object of the present invention is to provide an index image output apparatus and an index image output program, which produce thumbnail images from a plurality of images recorded as image data files, and arranges the thumbnail images in an array to form an index image that contains such thumbnail images that permit discrimination between image data files of different formats.

Another object of the present invention is to provide an index image output apparatus and an index image output program, which produce an index image that contains such thumbnail images that permit distinguishing those images which contain an identical subject.

According to the present invention, an index image output apparatus comprises a device for detecting image formats of the respective image data files; and a device for attaching data representative of the detected image formats to the thumbnail images of the respective image data files, if the image formats of the image data files are not the same.

According to present invention, another index image output apparatus comprises a device for detecting the image formats of the respective image data files; and a device for superimposing distinguishing data on the thumbnail image of each of the image data files of the first image format, so as to distinguish the image data files of the first image format from the image data files of the second and other image formats.

According to the present invention, still another index image output apparatus comprises an image distinguishing device that analyzes the respective image data files to determine whether there are a plurality of images of an identical subject or not; and a device for attaching distinguishing data to the thumbnail image of at least one of the images of the identical subject, the distinguishing data indicating that there are other images of the same subject as the one image whose thumbnail image has the distinguishing data attached.

The image distinguishing device may compares image data of the respective image data files with each other, to determine which image data files contain images of an identical subject.

It is possible to provide those image data files which record images of an identical subject with such additional data that indicate that the images contained in these image data files are identical to each other. In that case, the image distinguishing device checks if the respective image data files are provided with the additional data.

The image distinguishing device may determine whether there are a plurality of images of an identical subject, based on at least one of data indicating date and time of each shot, shooting environment data set according to environmental conditions of each subject and file names of the respective image data files.

According to a preferred embodiment, the distinguishing data is attached to the thumbnail image of a representative one of the images of the identical subject, and the thumbnail images of other of the images of the identical subject are excluded from the index image. If the images of the identical subject are recorded in different formats, including RAW format, the image recorded in RAW format is preferably chosen as the representative image.

The distinguishing data is preferably data of a rectangular frame image of a particular color that is superimposed on marginal or peripheral areas of the thumbnail image.

According to the present invention, an index image output program makes a computer work as a device for producing thumbnail images from a plurality of images recorded as image data files; a device for detecting image formats of the respective image data files; a device for attaching data representative of the detected image formats to the thumbnail images of the respective image data files, if there are image data files of different image formats from each other; and a device for arranging the thumbnail images in an array to form an index image.

According to the present invention, another index image output program makes a computer work as a device for producing thumbnail images from a plurality of images recorded as image data files; a device for analyzing the respective image data files to determine whether there are a plurality of images of an identical subject; a device for attaching distinguishing data to the thumbnail image of at least one of the images of the identical subject, the distinguishing data indicating that there are other images of the same subject as the one image whose thumbnail image has the distinguishing data attached; and a device for arranging the thumbnail images in an array to form an index image.

According to the present invention, the image formats of the respective image data files are determined, and if there are different image formats, data representative of the determined image formats are attached to the thumbnail images of the respective image data files. Thus, it is easy to discriminate between the images recorded in different image formats, e.g. between the RAW images and the JPEG images.

Since those image data files which record image data of an identical subject are determined, and distinguishing data is attached to these image data files, it is easy to distinguish those images which are captured simultaneously from an identical subject. Thus, it is easy to detect that image data of an identical subject is recorded both in RAW format and JPEG format, or that a plurality of images are captured simultaneously from an identical subject through successive exposures or auto bracket exposures.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating a computer system which the present invention is applied to;

FIG. 2 is an explanatory diagram illustrating how a distinguishing thumbnail image is produced;

FIG. 3 is an explanatory diagram illustrating an example of an index image;

FIG. 4 is a flow chart illustrating a sequence of producing an index image;

FIG. 5 is a flow chart illustrating a sequence of producing an index image, according to a second embodiment of the present invention;

FIG. 6 is a flow chart illustrating how a distinguishing thumbnail image is produced in the second embodiment;

FIG. 7 is an explanatory diagram illustrating an example of an index image produced in the second embodiment;

FIG. 8 is a conceptual diagram illustrating a structure of an image data file;

FIG. 9 is an explanatory diagram illustrating an example of a distinguishing thumbnail image according to a third embodiment of the present invention; and

FIG. 10 is an explanatory diagram illustrating an example of a distinguishing thumbnail image according to a fourth embodiment of the present invention.

### DESCRIPTION OF THE PREFERRED EMBODIMENTS

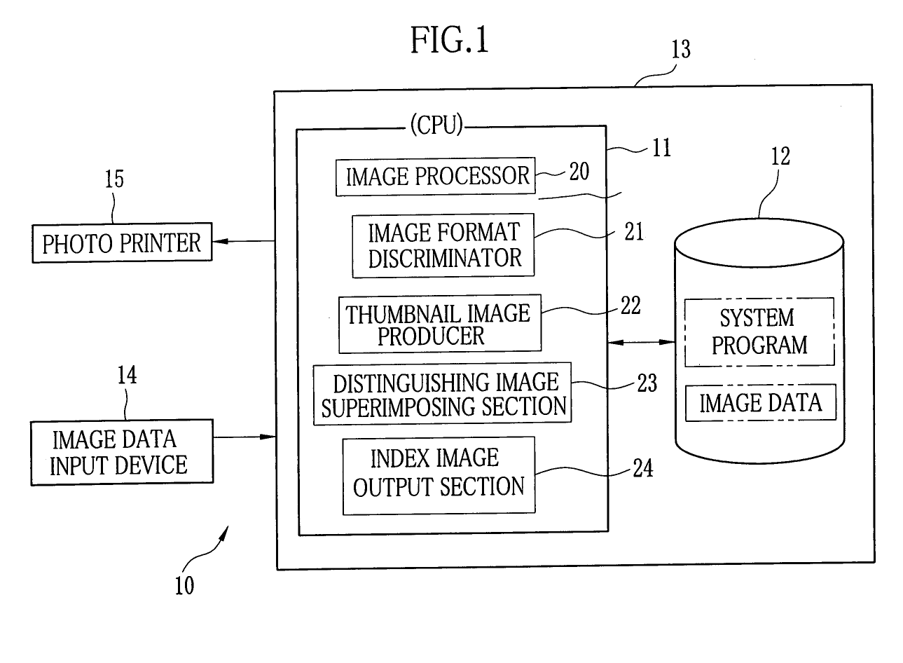

In FIG. 1, a computer system 10 is provided with a computer body 13 and an image data input device 14 for inputting image data files in the computer body 13. The computer body 13 is provided with a CPU 11 and a storage device 12. Although it is not illustrated in the drawings, the image data input device 14 is provided with a film scanner for reading photographic images from developed photo filmstrips, a memory card reader for reading image data files from memory cards that store the image data as captured by digital cameras or the like, an optical disc drive for reading image data files from optical discs like CD-ROM, and other kinds of data reading devices. The image data files input in the computer body 13 are memorized in the storage device 12.

A photo printer 15 is connected to the computer body 13, so that the photo printer 15 prints images on photographic paper based on the image data files output from the computer body 13. Concretely, the photo printer 15 exposes the photographic paper based on the image data files, processes the exposed photographic paper for development, washes and dries the developed photographic paper, to produce photo prints.

The storage device 12 stores a system program. The CPU 11 executes the system program, thereby causing the computer body 13 to function as an image processing device including an image processor 20. The CPU 11 also causes the computer body 13 to function as an index image output apparatus that is constituted of an image format discriminator 21, a thumbnail image producer 22, a distinguishing image superimposing section 23 and an index image output section 24.

The image processor 20 processes the image data files through gradation conversion, color conversion and the like, to correct the quality of images printed by the photo printer 15. The image processor 20 also carries out a format conversion process for converting RAW image data files, the image data recorded in the RAW format files, which may be included in the input image data files, into image data files of an ordinary format. This process is called a digital image development.

The RAW image data file contains such image data that is obtained by digitalizing original image signals, which are output from an imaging device of a digital camera or the like, without subjecting them to the gradation conversion and color conversion. Therefore, the RAW image data file contains information on the original gradation of the optical image of the subject as detected through the imaging device. Because of its huge data size, the RAW image data file is practically compressed according to a lossless compression format that is standardized by each individual digital camera maker.

The image processor 20 expands the compressed RAW image data file, and converts the RAW image, which has 12-bit gradation information (4096 tonal levels) for each of the three primary colors: red, green and blue, into uncompressed image of a general image format, wherein gradation information is expressed in 8-bit (256 tonal levels) for each of the three primary colors. Note that the image processor 20 converts the RAW image into the general format image after correcting the image quality. For example, gradation and white-balance are corrected so as to compensate for over- or under exposure at the imaging device, and for a difference in color-sensitivity between human eyes and image sensors of the imaging device.

The image format discriminator 21 analyzes header data of each image data file and its extension of file name, to determine image format of the image data file. Then, the image format discriminator 21 discriminates images of the RAW format from ones of other formats, such as JPEG, EXIF, TIFF and so forth. The thumbnail image producer 22 produces a thumbnail image from each of the input image data files. The thumbnail image is an image that is reduced in size by converting the input image data to have a lower resolution, and is used for producing an index image, as set forth later in detail.

The distinguishing image superimposing section 23 superimposes a distinguishing image on each of those thumbnail images which are produced from the RAW image, in order to distinguish the RAW images from other format images. So the thumbnail image with the distinguishing image indicates that the corresponding image is recorded as the RAW image data file.

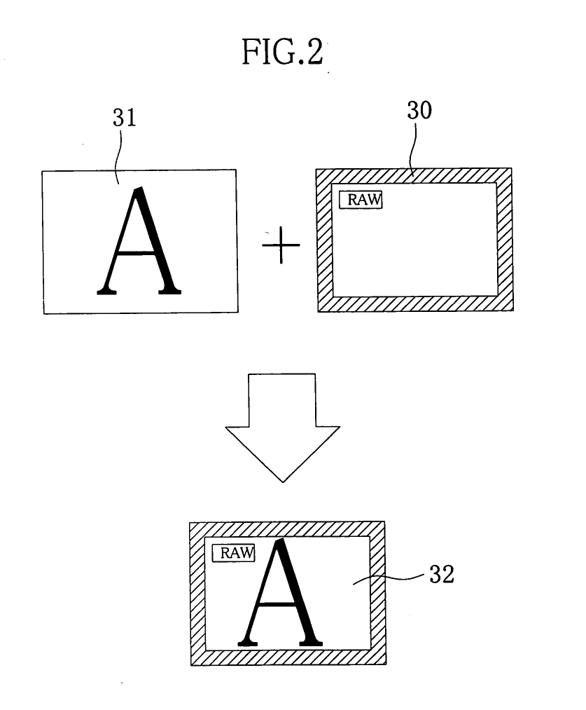

FIG. 2 shows an example of distinguishing image 30, which is an image of a rectangular frame of a particular color, e.g. red, and indicia “RAW” is provided inside the rectangular frame. The distinguishing image 30 is previously stored and superimposed on a thumbnail image 31 that is produced from the RAW image. The distinguishing image superimposing section 23 superimposes the distinguishing image 30 on the thumbnail image 31, to produce a distinguishing thumbnail image 32 that contains the thumbnail image 31 in a rectangular red frame, and is marked with the indicia “RAW”.

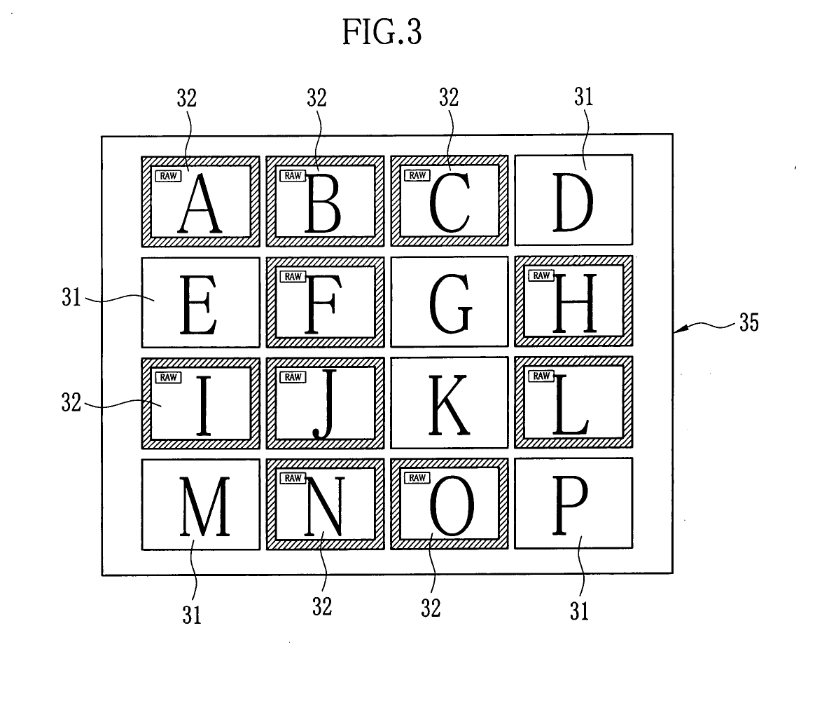

The index image output section 24 produces an index image 35, as shown for example in FIG. 3, from the thumbnail images 31 produced by the thumbnail image producer 22, and from the distinguishing thumbnail images 32 as well if the input image data files include the RAW image data files. The index image output section 24 decides the order of matrix arrangement of the thumbnail images to form the index image 35, for example, depending upon the order of file names of the input image data files. Thus, the index image 35 contains the distinguishing thumbnail images 32 for the RAW image data files, and the ordinary thumbnail images 31 for the image data files of other format.

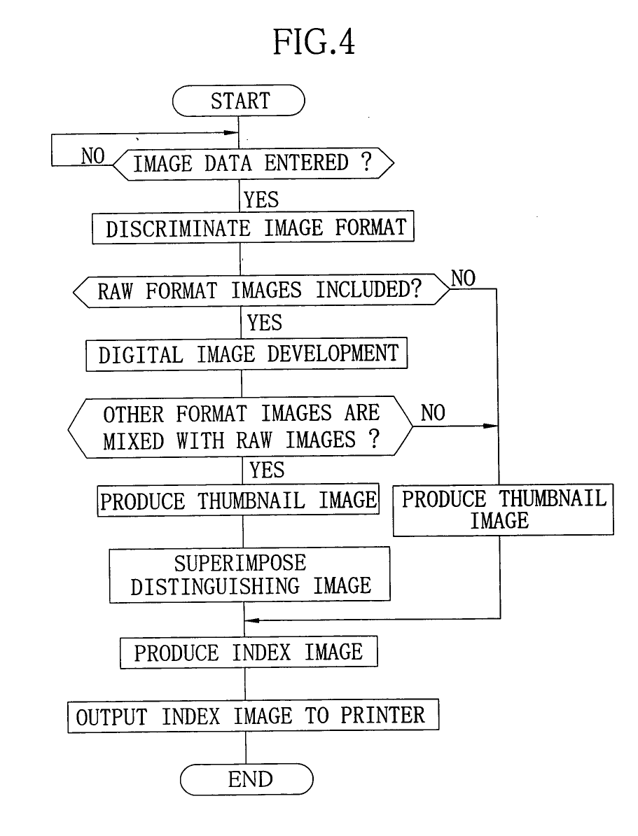

Now the operation of the embodiment configured as above will be described with reference to the flow chart of FIG. 4. When the CPU 11 executes the system program stored in the storage device 12, the computer body 13 functions as the image processing device and the index image output apparatus. When a developed photo filmstrip is set in the image data input device 14, the film scanner scans the photo filmstrip to read the photographed images, converts the read images into image data, and inputs the image data in the computer body 13. When a storage medium storing image data files, such as a memory card or an optical disc, is set in the image data input device 14, the image data files are read out from the storage medium and fed to the computer body 13.

The CPU 11 memorizes the input image data files in the storage device 12. When all of the image data files are completely input in the computer body 13, the CPU 11 starts reading the image data files seriatim from the storage device 12, to determine the format of each image data file in the image format discriminator 21. The image format discriminator 21 analyzes the file extension and the header data of each image data file, to discriminate the RAW image data files from other format image data files.

The image processor 20 carries out the digital image development of the RAW image data files, whereby the compressed RAW image data files are expanded and subjected to the gradation and color conversion processes for controlling image quality. The thumbnail image producer 22 produces a thumbnail image from each of the image data files. Note that an image data file of the EXIF format includes image data of its thumbnail in the file, so the thumbnail image producer 22 just extracts the thumbnail image data from the EXIF image data file. From other format image data files, the thumbnail image producer 22 produces the thumbnail image data by reducing the resolution of the image to about one-quarter of the original one.

After determining the formats of the respective image data files, the CPU 11 checks if there are the RAW image data files and other format image data files in the input image data files. If it is determined that the entire input image data files are of the RAW format, or of other formats than the RAW format, the index image output section 24 produces an index image that contains ordinary thumbnail images 31 alone. Data of the index image is output to the photo printer 15, so the photo printer 15 makes an index photo print containing ordinary thumbnail images 31 alone.

On the contrary, if there are the RAW image data files and other format image data files, the distinguishing image superimposing section 23 produces a distinguishing thumbnail image 32 for each of the RAW image data files by superimposing the distinguishing image 30 on the thumbnail image 31 of the RAW image data.

Using the distinguishing thumbnail images 32 for the RAW image and the ordinary thumbnail images 31 for the other format images, the index image output section 24 produces an index image, as shown for example by 35 in FIG. 3, after deciding the arrangement of the respective thumbnail images within the index image. Then the index image output section 24 outputs data of the index image to the photo printer 15, so the photo printer 15 makes an index photo print that contains the index image 35 consisting of the distinguishing thumbnail images 32 and the ordinary thumbnail images 31. Since the distinguishing thumbnail images 32 show that the corresponding image data files are recorded in the RAW format, it becomes easy for the customer to order photo prints from the RAW image data files only.

Although the distinguishing thumbnail image 32 is produced for the RAW image in the above embodiment, it is alternatively possible to produce an ordinary thumbnail image for the RAW image while producing a distinguishing thumbnail image for another format image. The present invention is not limited to producing an index image that distinguishes the RAW images from other format images. It is possible to produce an index image that allows discrimination between image data of lossy-compression formats involving image degradation, such as JPEG and EXIF, and image data pf lossless formats involving less or no image degradation, such as RAW and uncompressed TIFF.

Next, a second embodiment of the present invention will be described. In the second embodiment, such a digital camera is used that can record an image captured at one exposure different data formats, e.g. as a couple of image data files of the RAW format and JPEG format. In the second embodiment, equivalent elements are designated by the same reference numerals as in the first embodiment, so detailed description of these elements will be omitted to avoid redundancy.

When the image data files recorded by the above digital camera are input, an index image output apparatus produces ordinary thumbnail images 31 from the respective image data files. After producing the thumbnail images 31, images of the respective image data files are analyzed to check if there are a number of images containing an identical subject. If any of the image data files do not contain the same image, an index image consisting of the ordinary thumbnail images 31 is produced.

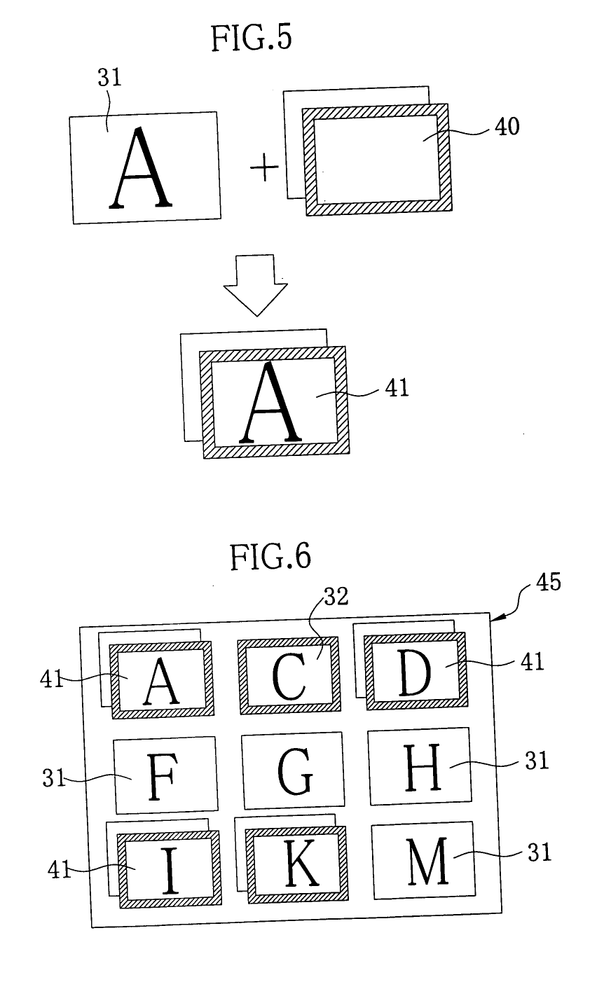

If, on the contrary, an image captured by the digital camera is recorded double as a RAW image data file and a JPEG image data file, image data of these image data files represent the same image of an identical subject. In that case, as shown in FIG. 5, a distinguishing image 40 is superimposed on the ordinary thumbnail image 31 that is produced from the RAW image data file of the same image as the JPEG image data file. Thus, a distinguishing thumbnail image 41 is produced. The RAW image data file and the JPEG image data file of the identical subject are given file names with successive serial numbers, wherein the RAW image data file is numbered first in every couple. Thus, it is possible to discriminate between the RAW image data and the JPEG image data of the identical subject, and superimpose the distinguishing image 40 merely on the thumbnail image of the RAW image.

When all the images of the image data files have gone through the above analysis, an index image 45 is produced from the distinguishing thumbnail images 41 and the ordinary thumbnail images 31, as shown in FIG. 6. At that time, such ordinary thumbnail images that represent the same images as the distinguishing thumbnail images 41 are excluded from the index image 45. That is, if there are RAW image data and JPEG image data of an identical subject, an ordinary thumbnail image produced from the JPEG image data is not used for producing the index image 45, and only the distinguishing thumbnail image 41 that is produced from the thumbnail image of the RAW image data and the distinguishing image 40 is adopted in the index image 45. Thus, the index image 45 avoids duplication of such thumbnail images that represent the same content. Omitting redundant thumbnail images saves space for printing an index print.

Data of the index image 45 is outputted to the photo printer 15, to produce an index print. Since the distinguishing thumbnail image 41 shows that the image represented by this thumbnail image 41 is recorded simultaneously as RAW image data and JPEG image data, it is obvious from the index print what kinds of formats are used for recording the respective images.

It is possible to use another distinguishing image, like the distinguishing image 30 shown in FIG. 2, for distinguishing such an image that is recorded only in a particular format, e.g. as a RAW image, from an image that is recorded simultaneously as a RAW image and a JPEG image. In that case, the image recorded in the RAW format only is represented by a distinguishing thumbnail image 32 fringed with a single frame, while the image recorded both in the RAW and JPEG formats is represented by the distinguishing thumbnail image 41 fringed with the double-frame distinguishing image 40, and the image recorded in the JPEG format is represented by the ordinary thumbnail image 31.

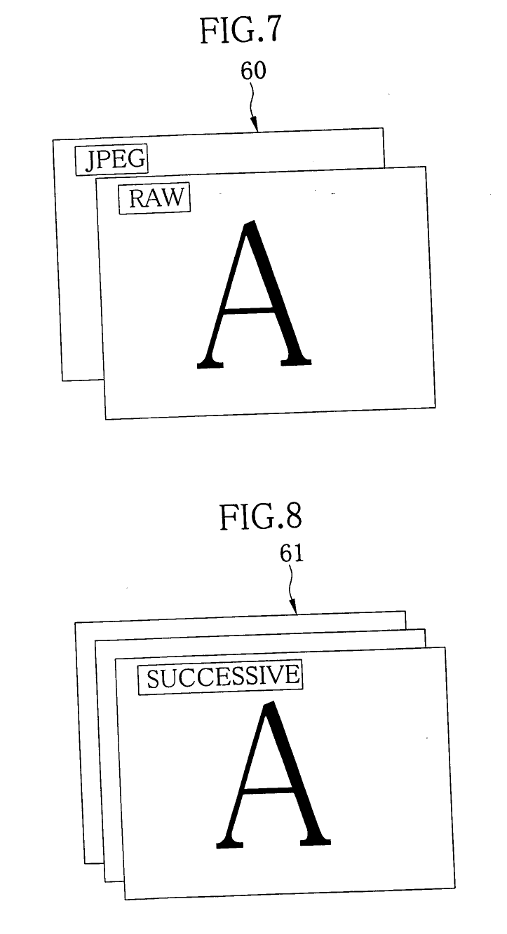

It is alternatively possible to produce a distinguishing thumbnail image 60 as shown in FIG. 7, that shows that an identical subject is recorded as images of different formats, e.g. as a RAW image and a JPEG image. In that case, the distinguishing thumbnail image 60 includes indicia indicating the different image data formats.

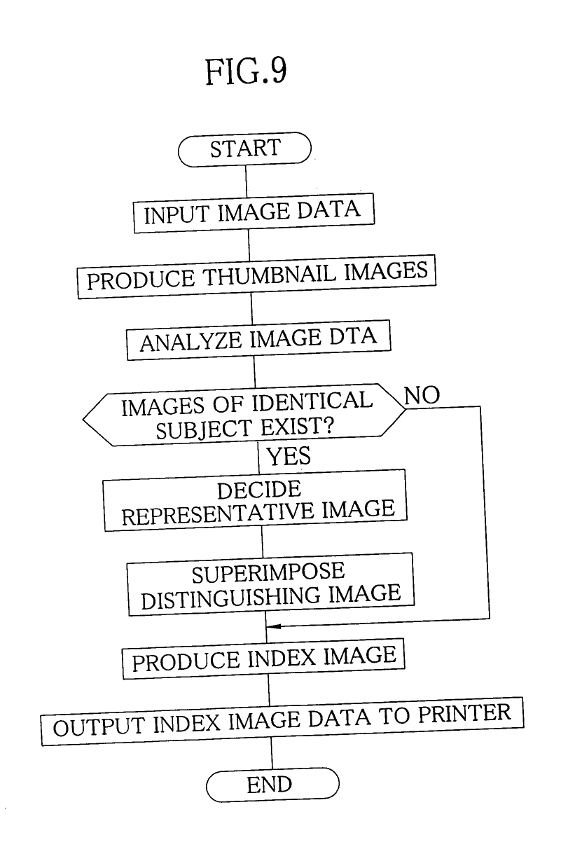

Application of the present invention is not limited to the above-described cases where a series of images are recorded in different data formats from each other, or images of an identical subject are recorded simultaneously in different data formats. The present invention is also applicable to the successive exposures where a plurality of images are captured from a subject successively at one shot and are recorded in the same format, or to the auto bracket exposures where a plurality of images are captured successively from a subject while changing exposure conditions. In those cases, it is mostly useless to arrange thumbnail images of all the successively captured images on an index image. It is rather preferable to select a representative image from among the successive images, and produce a distinguishing thumbnail image 61 by superimposing a distinguishing image or indicia indicating that this is a series of successive images on a thumbnail image of the representative image, as shown in FIGS. 8 and 9.

In the above embodiment, the image data of the respective image data files are subjected to the analysis for detecting such images that contain an identical subject. However, the image analysis needs comparing individual pixels of the respective images to one another, to extract coincident pixel areas. Therefore, as for high-resolution images, it takes a long time for detecting coincidence of the subjects. To avoid this problem, it is possible to integrate data of simultaneous shots in respective image data files which record those images captured simultaneously from an identical subject. Note that the simultaneously shot images can be ones taken through successive exposures and recorded in the same format, or taken at one exposure and recorded in different formats. By checking the simultaneous shot data, the index image output apparatus can determine whether a plurality of images of an identical subject exit or not, without the need for comparing the image data between the image data files.

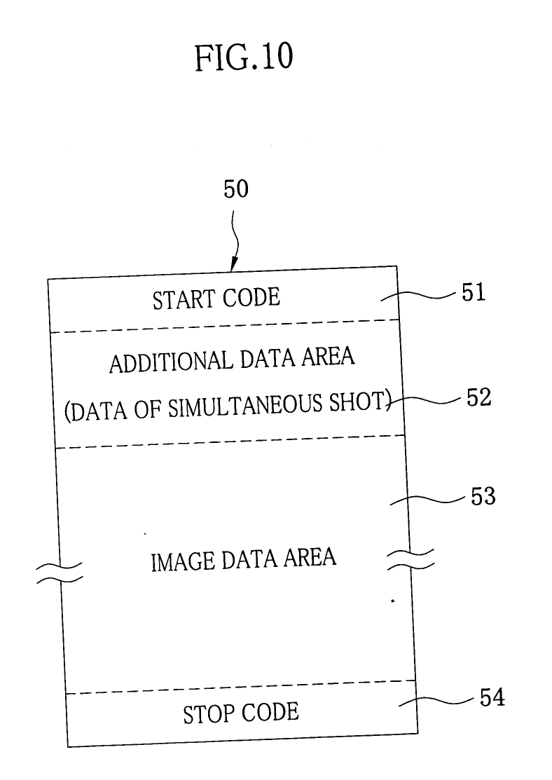

FIG. 10 shows an example of a file structure of an image data file 50. The image data file 50 mainly consists of a start code 51, an additional data area 52, an image data area 53 and a stop code 54. The start code 51 consists of basic data, including data relating to the type and name of the image data file 50, and data for defining image format. The additional data area 52 consists of data of the date and time of each shot and data of shooting environment, which are attached by the digital camera on producing the image data file 50. The shooting environment data includes data of the camera type, data of exposure conditions like a shutter speed and an exposure value, and data of image-processing done by the digital camera. The image data area 53 is a main area of the image data and consists of data of tonal values of individual pixels. The stop code 54 is data indicating the end of the image data file.

To integrate the simultaneous shot data into the image data file of each of the simultaneously shot images, the additional data area 52 is utilized. The simultaneous shot data for aseries of simultaneously shot images should preferably be different from one for another series of simultaneously shot images, so as to avoid confusion between different series. The simultaneous shot data may alternatively be a flag. In that case, of the image data files having the flag, the date and time data and/or the shooting environment data is compared with each other, to sort out those image data files which record a series of simultaneously shot images of an identical subject. As for those digital cameras which give file names of successive serial numbers, or the same file name with different file extensions to a series of different format images of an identical subject, it is possible to discriminate the images of an identical subject based on their file names. That is, even where there are a plurality of RAW images and JPEG images or where there are a plurality of series of simultaneously shot images, images of an identical subject may be discriminated with high accuracy, by comparing the data of date and time of each shot, the shooting environmental data and the file names of these images.

Although the present invention has been described with respect to the preferred embodiments, the present invention is not to be limited to the above embodiments but, on the contrary, various modifications will be possible without departing from the scope of claims appended hereto.

What is claimed is:

1. An index image output apparatus that produces thumbnail images from a plurality of images recorded as image data files, and arranges the thumbnail images in an array to form an index image, said index image output apparatus comprising:
a device for detecting image formats of the respective image data files; and
a device for attaching data representative of the detected image formats to the thumbnail images of the respective image data files, if the image formats of the image data files are not the same.

2. An index image output apparatus that produces thumbnail images from a plurality of images recorded as image data files of at least first and second image formats, and arranges the thumbnail images in an array to form an index image, said index image output apparatus comprising:
a device for detecting the image formats of the respective image data files; and
a device for superimposing distinguishing data on the thumbnail image of each of the image data files of the first image format, so as to distinguish the image data files of the first image format from the image data files of the second and other image formats.

3. An index image output apparatus as claimed in claim 2, wherein said distinguishing data is data of a rectangular frame image of a particular color that is superimposed on marginal or peripheral areas of the thumbnail image.

4. An index image output apparatus that produces thumbnail images from a plurality of images recorded as image data files, and arranges the thumbnail images in an array to form an index image, said index image output apparatus comprising:
an image distinguishing device that analyzes the respective image data files to determine whether there are a plurality of images of an identical subject or not; and
a device for attaching distinguishing data to the thumbnail image of at least one of the images of the identical subject, said distinguishing data indicating that there are other images of the same subject as the one image whose thumbnail image has said distinguishing data attached.

5. An index image output apparatus as claimed in claim 4, wherein said image distinguishing device compares image data of the respective image data files with each other, to determine which image data files contain images of an identical subject.

6. An index image output apparatus as claimed in claim 4, wherein those image data files which record images of an identical subject are provided with such additional data that indicate that the images contained in these image data files are identical to each other, and said image distinguishing device checks if the respective image data files are provided with said additional data.

7. An index image output apparatus as claimed in claim 4, wherein said image distinguishing device determines whether there are a plurality of images of an identical subject, based on at least one of data indicating date and time of each shot, shooting environment data set according to environmental conditions of each subject and file names of the respective image data files.

8. An index image output apparatus as claimed in claim 4, wherein said distinguishing data is attached to the thumbnail image of a representative one of the images of the identical subject, and the thumbnail images of other of the images of the identical subject are excluded from the index image.

9. An index image output apparatus as claimed in claim 8, wherein if the images of the identical subject are recorded in different formats, including RAW format, the image recorded in RAW format is chosen as said representative image.

10. An index image output apparatus as claimed in claim 4, wherein said distinguishing data is data of a rectangular frame image of a particular color that is superimposed on marginal or peripheral areas of the thumbnail image.

11. An index image output program for outputting an index image, said program making a computer work as
a device for producing thumbnail images from a plurality of images recorded as image data files;
a device for detecting image formats of the respective image data files;
a device for attaching data representative of the detected image formats to the thumbnail images of the respective image data files, if there are image data files of different image formats from each other; and
a device for arranging the thumbnail images in an array to form an index image.

12. An index image output program for outputting an index image, said index image output program making a computer work as
a device for producing thumbnail images from a plurality of images recorded as image data files;
a device for analyzing the respective image data files to determine whether there are a plurality of images of an identical subject;
a device for attaching distinguishing data to the thumbnail image of at least one of the images of the identical subject, said distinguishing data indicating that there are other images of the same subject as the one image whose thumbnail image has said distinguishing data attached; and
a device for arranging the thumbnail images in an array to form an index image.
